(19) United States
(12) Patent Application Publication
(10) Pub. No.: US 2026/0073347 A1
(43) Pub. Date: Mar. 12, 2026

(54) Systems and Methods for Complexity-based Matching Across Delivery Verticals

(71) Applicant: Uber Technologies, Inc., San Francisco, CA (US)

(72) Inventors: Carly Wahlberg, San Francisco, CA (US); Wafic El-Assi, Toronto (CA); Albert Lee, Brooklyn, NY (US); Nikolas Thorun, Santiago (CL); Jacob Edward Sudek, Seattle, WA (US); Dustin Wang, San Francisco, CA (US); Diego Carey Astaburuaga, Santiago (CL); Samuel Lite, New York, NY (US); Ankur Jain, Jersey City, NJ (US); Mustafa Sahin, New York, NY (US); Eric Benjamin Janofsky, New York, NY (US); Cheng Hao Zheng, Queens, NY (US)

(21) Appl. No.: 18/827,007

(22) Filed: Sep. 6, 2024

(51) Int. Cl. G06Q 10/0834; G06Q 10/0631; G06Q 10/083

(52) U.S. Cl. CPC G06Q 10/0834; G06Q 10/063112; G06Q 10/0838

(57) ABSTRACT

An example computer-implemented method includes accessing service request data indicative of a service request, the service request having a service type and one or more service parameters. The method includes computing a complexity score associated with the service request based on the service type and the one or more service parameters. The method includes selecting a first courier of a plurality of candidate couriers based on the complexity score associated with the service request. The method includes outputting first instructions to a first courier device associated with the first courier. The first instructions are executable by the first courier device to cause a service assignment to be provided for display via a user interface of the first courier device, the service assignment indicating the first courier is to perform the service request.

### FIELD

The present disclosure generally relates to computing technology for delivery services. More particularly, the present disclosure is directed to systems and methods for complexity-based matching across delivery verticals.

### BACKGROUND

Delivery services allow a user to request a service that may be performed by a vehicle or courier. For instance, a user may request, through a delivery service application, a delivery service having a pick-up location, a drop-off location, and items for delivery. A courier can be assigned to perform the delivery service for the user. This can include transporting the delivery of the items to the drop-off location.

### SUMMARY

One example aspect of the present disclosure is directed to a computer-implemented method. The method includes accessing service request data indicative of a service request, the service request having a service type and one or more service parameters. The method includes computing a complexity score associated with the service request based on the service type and the one or more service parameters. The method includes selecting a first courier of a plurality of candidate couriers based on the complexity score associated with the service request. The method includes outputting first instructions to a first courier device associated with the first courier. The first instructions are executable by the first courier device to cause a service assignment to be provided for display via a user interface of the first courier device, the service assignment indicating the first courier is to perform the service request.

In some implementations, the method includes: accessing first courier data associated with the first courier, the first courier data describing values of one or more courier-level features associated with the first courier; and computing a complexity threshold associated with the first courier based on the first courier data. Selecting the first courier includes associating the first courier and the service request based on a comparison of the complexity score associated with the service request to the complexity threshold associated with the first courier.

In some implementations, selecting the first courier includes: computing a first time estimate for the first courier to complete the service request based on the service type and the one or more service parameters; computing a first adjusted time estimate by adjusting the first time estimate based on the first courier data; and selecting the first courier based on the first adjusted time estimate.

In some implementations, the method includes: accessing second courier data associated with a second courier, the second courier data describing values of the one or more courier-level features associated with the second courier; and computing a second time estimate for the second courier to complete the service request based on the service type and the one or more service parameters. Selecting the first courier is based on a comparison between the first adjusted time estimate and the second time estimate.

In some implementations, the one or more courier-level features include historical service data respective to a plurality of service types. The service type of the service request is a first service type of the plurality of service types; and computing the first adjusted time estimate includes adjusting the first time estimate based on the historical service data of the first courier.

In some implementations, selecting the first courier includes: accessing a service count of a second service type of the plurality of service types in the historical service data of the first courier, the second service type having a second base complexity that is lower than a first base complexity of the first service type; computing a service count threshold indicative of a number of services of the second service type to be completed by the first courier prior to assigning the first courier to service requests of the first service type; computing that the service count of the second service type satisfies the service count threshold; and selecting the first courier in response to computing that the service count of the second service type is greater than the service count threshold.

In some implementations, the method includes: computing a historical complexity score associated with the historical service data of the first courier. Adjusting the first time estimate is based on a comparison of the historical complexity score to the complexity score of the service request.

In some implementations, adjusting the first time estimate includes decreasing the first time estimate if the historical complexity score is greater than the complexity score of the service request.

In some implementations, the one or more courier-level features include a courier rank within a plurality of courier ranks. The method includes computing a first courier rank of the first courier, the first courier rank within the plurality of courier ranks. Computing the first adjusted time estimate is based on the first courier rank.

In some implementations, the first courier rank includes: accessing data indicative of a ranking score of the first courier; accessing a courier rank table indicating a tiered relationship between ranking scores and the plurality of courier ranks; and computing the first courier rank based on a comparison of the ranking score of the first courier to the courier rank table based on the tiered relationship between ranking scores and the plurality of courier ranks.

In some implementations, the method includes outputting data indicative of the first courier rank to the first courier device.

In some implementations, computing the first adjusted time estimate includes: computing a first time modifier associated with a first courier rank of the first courier; and applying the first time modifier to the first time estimate to compute the first adjusted time estimate.

In some implementations, computing the first time modifier includes: accessing a time modifier table indicating a respective relationship between a plurality of time modifiers and the plurality of courier ranks; and computing the first time modifier based on a comparison between the first courier rank and the time modifier table based on the respective relationship between the plurality of time modifiers and the plurality of courier ranks.

In some implementations, the first time estimate is based on a first distance estimate indicative of distance traveled by the first courier in completing the service request. In some implementations, computing the first adjusted time estimate includes: computing a first distance modifier associated with a first courier rank of the first courier; applying the first distance modifier to the first distance estimate to produce a first adjusted distance estimate; and computing the first adjusted time estimate based on the first adjusted distance estimate.

In some implementations, the service type includes at least one of: food delivery, courier-packed retail delivery, merchant-packed retail delivery, courier-packed grocery delivery, or merchant-packed grocery delivery.

In some implementations, the one or more service parameters are indicative of at least one of: a number of items to be transported, an order size, a batch size, a hyperbatching attribute, an item weight, an item size, an origin, an intermediate destination, a final destination, a service quality, a service priority, a service requirements, service metrics, or a product type.

Another example aspect of the present disclosure is directed to a computing system. The computing system includes one or more processors; and one or more non-transitory, computer-readable media storing instructions that are executable by the one or more processors to cause the computing system to perform operations. The operations include: accessing service request data indicative of a service request, the service request having a service type and one or more service parameters; computing a complexity score associated with the service request based on the service type and the one or more service parameters; selecting a first courier of a plurality of candidate couriers based on the complexity score associated with the service request; and outputting first instructions to a first courier device associated with the first courier. The first instructions are executable by the first courier device to cause a service assignment to be provided for display via a user interface of the first courier device, the service assignment indicating the first courier is to perform the service request.

In some implementations, the operations include: accessing first courier data associated with the first courier, the first courier data describing values of one or more courier-level features associated with the first courier; and computing a complexity threshold associated with the first courier based on the first courier data. In some implementations, selecting the first courier includes associating the first courier and the service request based on a comparison of the complexity score associated with the service request to the complexity threshold associated with the first courier.

In some implementations, selecting the first courier includes: computing a first time estimate for the first courier to complete the service request based on the service type and the one or more service parameters; computing a first adjusted time estimate by adjusting the first time estimate based on the first courier data; and selecting the first courier based on the first adjusted time estimate.

Yet another aspect of the present disclosure is directed to one or more non-transitory, computer-readable media storing instructions comprising operations. The operations include: accessing service request data indicative of a service request, the service request having a service type and one or more service parameters; computing a complexity score associated with the service request based on the service type and the one or more service parameters; selecting a first courier of a plurality of candidate couriers based on the complexity score associated with the service request; and outputting first instructions to a first courier device associated with the first courier. The first instructions are executable by the first courier device to cause a service assignment to be provided for display via a user interface of the first courier device, the service assignment indicating the first courier is to perform the service request.

### BRIEF DESCRIPTION OF THE DRAWINGS

Detailed discussion of embodiments directed to one of ordinary skill in the art are set forth in the specification, which makes reference to the appended figures, in which:

FIG. 1 depicts a block diagram of an example system for assigning couriers to service requests according to example embodiments of the present disclosure.

FIG. 2 depicts an example data structure of a memory according to example embodiments of the present disclosure.

FIG. 3 depicts an example data structure of a memory according to example embodiments of the present disclosure.

FIG. 4 depicts an example geographic area according to example embodiments of the present disclosure.

FIGS. 5A and 5B depict an example courier rank according to example embodiments of the present disclosure.

FIGS. 6A through 6C depict example user interfaces providing courier-level feature information according to example embodiments of the present disclosure.

FIG. 7 depicts a flowchart of an example method according to example embodiments of the present disclosure.

FIG. 8 depicts a flowchart of an example method according to example embodiments of the present disclosure.

FIG. 9 and FIG. 10 depict block diagrams of example systems according to example embodiments of the present disclosure.

### DETAILED DESCRIPTION

Generally, the present disclosure is directed to improved systems and methods for complexity-based matching across service verticals. More particularly, aspects of the present disclosure relate to coordinating delivery services between couriers based on complexity of the service request and courier-level features. The courier-level features can be indicative of the courier's service history, experience with complex services, etc. For example, the courier-level features can include a service count (or trip count) indicative of a number of service requests a courier has completed, the types of services, the complexity of those services, etc. As further described herein, the complexity of a service can be based on the level of responsibility for the courier and the amount of dynamic/different elements involved in a particular service request. The delivery services can be coordinated across multiple service verticals, or multiple types of delivery services, such as grocery delivery services, food delivery services, retail delivery services, and so on.

For example, a computing system can receive service request data indicative of a service request. The service request can have a service type and one or more service parameters. The service type can indicate a type of service to be performed (e.g., a service vertical) such as, for example, courier-packed or merchant-packed grocery or retail delivery services, or food delivery services, ride sharing services, or other vehicle sharing services. The service parameters can indicate aspects of the service request other than the type of service, such as, for example the number of items to be transported, order size, batch size, hyperbatching attribute, item weight, item size, origin, intermediate destination, final destination, service quality, service priority, service requirements, service metrics, or product type. The type of service and/or the service parameters can contribute to a complexity of the service request. For instance, a service request for delivering multiple types of items that must be packed by couriers may introduce more dynamic factors for a courier to perform than a food delivery service request where the food is bagged by the originating restaurant, which may only require a courier to pick up a bag from the service counter at the restaurant and drive to the requested location.

The varied complexity of delivery tasks, especially across multiple service verticals, can be inefficient for couriers who are relatively new to the delivery service. For instance, a courier with relatively few completed service requests may become discouraged by complicated delivery requests while the courier is still developing efficiency. As another example, a courier may experience uncertainty when repeatedly presented with service requests having a wide range of complexity. A courier may even elect to discontinue providing delivery services if the courier is repeatedly overwhelmed by complex service requests.

The present disclosure can provide a solution to these and other challenges. In particular, systems and methods according to aspects of the present disclosure can compute a complexity score associated with a service request and select a courier to perform the service request based on the complexity score and/or one or more courier-level features, such as service count. More particularly, in some implementations, the complexity score can be based on the service type and the service parameters of the service request. Certain service types (e.g., courier-packed grocery delivery) can have relatively higher associated complexity scores than others.

In some implementations, a service count threshold may be satisfied before assigning couriers to some service types. In this manner, couriers having courier-level features indicating higher degrees of experience can receive opportunities to perform more complex service requests, such as courier-packed grocery or retail delivery service requests. This may increase the earning potential of those couriers.

The technology of the present disclosure can also be utilized to improve the opportunities for couriers with courier-level features indicating relatively lower levels of experience. For example, these couriers can, at least initially, be provided with lower-complexity service requests. As the couriers gain experience in one vertical/service type, the technology described herein can interpolate the courier's experience to provide them with selected service requests across a new vertical/service type. This intelligent interpolation can provide couriers with opportunities to continue to increase earning potential, while doing so in a manner that allows the courier to remain efficient, even while performing services in a new vertical. In this manner, the less-experienced couriers can build efficiency and familiarity with the delivery service on less complex service requests without being overwhelmed, while still maintaining high earning potential and gaining access to new opportunities.

This can improve courier efficiency, confidence, and avoid newer courier turnover associated with being overwhelmed by complex service requests. Furthermore, improved courier efficiency can provide for improved customer experience. Customers requesting complex service tasks can be coordinated with the appropriate couriers, resulting in reduced delivery times, improved service quality, and improved customer retention.

Furthermore, systems and methods according to example aspects of the present disclosure can provide for numerous technical effects and benefits including improvements to computing technology. The present disclosure uniquely recognizes that certain courier-level features can correspond to courier efficiency in service requests. The present disclosure further recognizes that these efficiency gains can translate/be interpolated across service verticals. For instance, a courier who has primarily performed food delivery service requests may perform a grocery delivery service request with similar efficiency to a courier with a similar number of service requests, but who has primarily performed grocery delivery service requests.

Therefore, the present disclosure proposes utilizing these certain courier-level features in coordinating couriers and service requests. As one example, selecting a courier based on the courier-level features and the complexity score based on a type of service request, can coordinate couriers with appropriate-complexity service requests without requiring computation of a complex “efficiency” metric associated with a courier. The computation of courier-specific efficiency metrics can often be computationally-intensive, requiring significant computing resources to compute and store. In contrast, by using relatively simpler courier-level features as described herein, the computational resource usage associated with determining courier efficiency can be significantly reduced or eliminated. As another example, the present disclosure provides improved privacy for couriers, as it does not require in-depth analysis of a courier's performance to gauge efficiency.

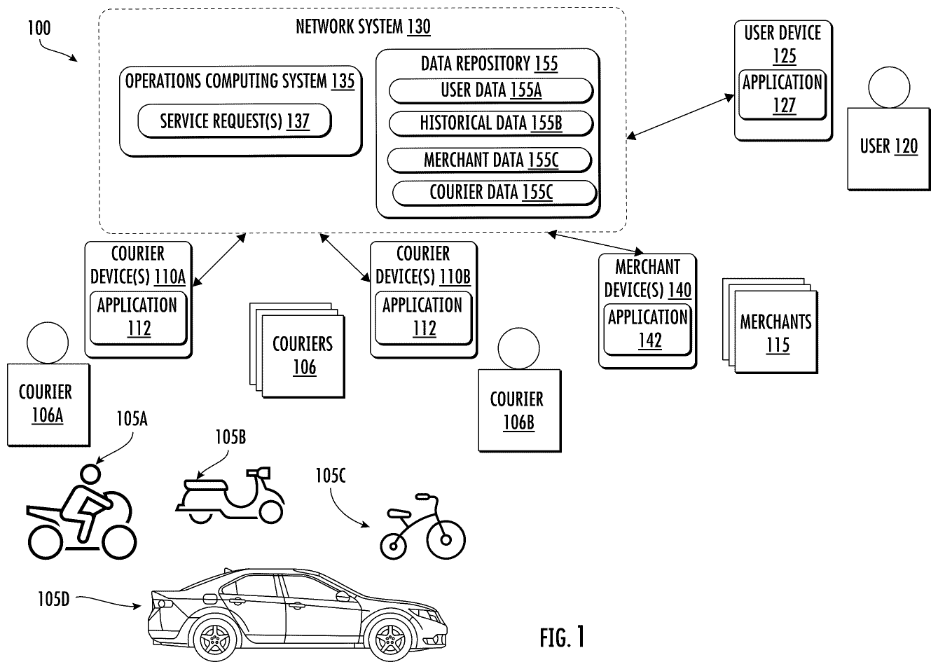

FIG. 1 depicts a block diagram of an example system 100 for strategic routing and distribution of orders for multi-location merchants. As illustrated in FIG. 1, system 100 can include one or more vehicles 105A-D (e.g., a car 105D, scooter 105B, motorcycle 105A, bicycle 105C) and one or more courier devices 110A-B that can be associated with one or more couriers 106 (E.g., first courier 106A and second courier 106B). In some examples, the one or more couriers are humans (e.g., that can operate a vehicle). In some examples, the courier can be non-human (e.g., vehicle, autonomous vehicle, autonomous robot). The one or more couriers 106A-B and the one or more courier devices 110A-B (e.g., an onboard tablet, a mobile device of a courier) can be associated with the one or more vehicles 105A-D. The courier devices 110A-B can include an application 112 associated with the grocery delivery service entity, which can run on the courier devices 110A-B.

The computing system 100 can include one or more merchants 115. The computing system can include a first merchant and a second merchant. The network system 130 can obtain and store data from merchants 115. For instance, data can be stored in data repository 155. Data repository 155 can include user data 155A associated with one or more users, historical data 155B, merchant data 155C, and courier data 155D. User data 155A can include data associated with one or more users (e.g., user 120). Historical data 155B can include data associated with prior use of services of a user, preference of a user, courier data, historic packing time, and the like. Merchant data 155C can include data associated with a merchant such as merchant inventory, merchant location, merchant item preparation time, merchant time to pack time, and the like. The inventory data associated with merchants 115 can be used to determine what item offerings to present to user 120 via user device 125 (e.g., via software application such as application 127).

Courier data 155D can include data associated with one or more couriers (e.g., courier 106A, courier 106B) such as a list of couriers that are online, a status, a location, a vehicle capacity, a vehicle type, or courier preferences. Additionally or alternatively, courier data 155D can include courier-level features associated with a courier, including present and/or past information associated with a courier. As one example, the one or more courier-level features can include historical service data respective to a plurality of service types. For example, the historical service data can include a service count (or trip count) indicative of a number of service requests that have been assigned to the courier, a number of service requests that have been successfully completed by the courier, and so on. The service count may be respective to each service type and/or aggregated from multiple service types. A status of a courier can include that the courier is currently providing a service, is available to provide a new service, etc. A location can include a past location, current location, future location, etc. For instance, a current location of the courier can be determined based on tracking a device associated with the courier. For instance, current location can include data indicative of GPS pings, Wi-Fi, IP address, device sensor data, cellular network, or user input. Location data can include data indicative of GPS pings, Wi-Fi, IP address, device sensor data, cellular network, user input, etc. transmitted over one or more communication networks. Courier preferences can include types of services, types of routes, location of the service, etc.

The merchants 115 (or courier 106A and courier 106B) can receive data indicative of a delivery service request from a user 120. For example, the user 120 can submit a request through a user device 125 associated with the user via a software application such as application 127. A network system 130 can include a computing system associated with a service entity that can facilitate a request for services from user 120. An operations computing system 135 associated with the delivery service entity can facilitate a request for services from user 120. For example, user 120 can submit a delivery service request through a user device 125 associated with the user 120 (e.g., via a software application such as application 127). Operations computing system 135 can receive the data indicative of service request(s) 137 from the user device 125. The operations computing system 135 can transmit data indicative of service request(s) 137 to a merchant device 140 associated with a merchant 115 (e.g., via a software application such as application 142).

The operations computing system 135 can receive data indicative of a merchant 115 accepting a service request 137. The data can include an expressed acceptance of the service request 137, triggered by a user at a merchant 115 selecting a user interface element of software application 142 to accept the request. In some implementations, the merchant device 140 can be configured to automatically accept (or reject) a service request based on the service parameters. The criteria for auto-acceptance or auto-rejection may be defined by a merchant 115, automatically defined based on the characteristics of the merchant (e.g., its capacity for orders and the current number of orders pending), or a default setting.

In some implementations, the data indicative of the merchant 115 accepting the service request 137 may be triggered by an implicit signal or user input indicating a status of the service request 137, with respect to the merchant. For example, the merchant may indicate (e.g., via an input to the UI) that grocery items are being packed, an estimated time to pack grocery items, food is being prepared, estimated preparation time, etc.

The operations computing system 135 can send a request to a courier device 110A associated with a courier 106A or a courier device 110B associated with courier 106B to complete the service request 137 (e.g., via a software application such as application 112). For instance, the operations computing system 135 can instruct one of the couriers 106A/106B to complete the service request 137 by travelling to a location associated with the merchant 115 associated with the service request 137 (e.g., a pick-up location), retrieving one or more items from the merchant 115 or the pick-up location, and/or travelling to a drop-off location associated with the service request 137. As an example, the operations computing system 135 can coordinate one or more service request(s) 137 between a plurality of candidate couriers including the courier 106A and the courier 106B, as described further herein.

The network system 130 can include a data repository 155. Data repository 155 can include user data 155A (e.g., data associated with user 120), historical data 155B (e.g., data associated with user 120, data associated with merchant(s) 115, data associated with couriers (e.g., courier 106A and courier 106B), merchant data 155C (e.g., real-time data associated with merchants 115, merchant inventory associated with merchants 115, merchant location information associated with merchants 115), courier data 155D (e.g., data associated with courier 106A or courier 106B), or any other relevant data (e.g., system-level data associated with a plurality of users, expected demand).

The operations computing system 135 can generate data indicative of the service request 137. This data can be indicative of an estimated time of departure, estimated time of arrival, estimated time to pack, estimated preparation time, real-time updates on order preparation, real-time updates on order packing, real-time updates on order location, real-time updates on courier location, or other information. The operations computing system 135 can provide data for display on a user device 125 (e.g., via application 127) indicative of updates on the service request 137. For example, an update can include an update about what stage of delivery the order is in (e.g., preparation, courier packing items, pick-up by courier, courier in route to destination location, courier approaching destination location, order delivered).

The operations computing system 135 can communicate data indicative of the delivery service assignment to a courier (e.g., a human courier, an autonomous vehicle courier, an autonomous robot courier). For instance, the operations computing system 135 can send a request to the courier device 110A of courier 106A or courier device 110B of courier 106B. The request (e.g., for the courier to accept the grocery delivery service assignment) can be communicated to courier 106A or courier 106B via the application 112 running on courier device 110A or courier device 110B associated with the respective courier. Additionally or alternatively, operations computing system 135 can send a request to a courier device (e.g., a tablet stored onboard the vehicle) of at least one of vehicles 105A-D. Courier 106A or courier 106B can provide user input to courier device 110A or courier device 110B (e.g., via the application 112) to accept or decline the delivery service request. In some examples, user input can be provided directly into application 112. Additionally or alternatively, user input can be provided via an application programing interface (API) or a third-party application. Data indicative of the acceptance or rejection of the request can be provided to operations computing system 135.

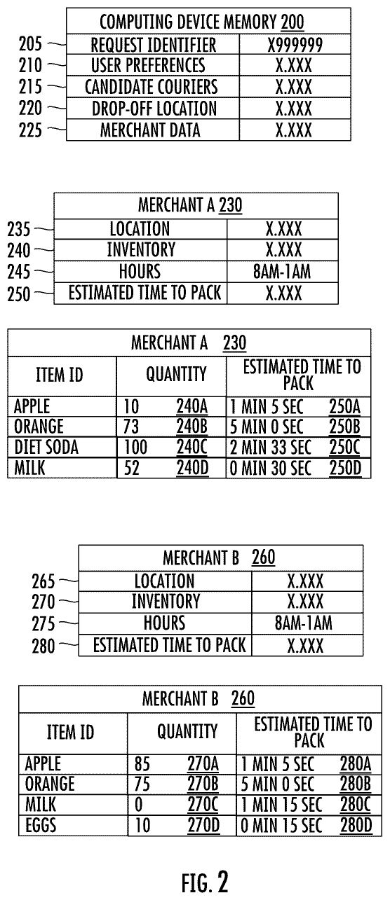

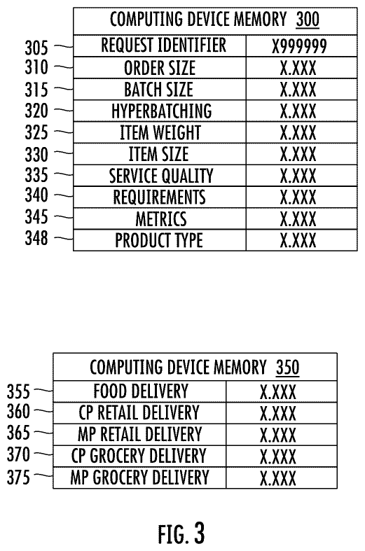

As described herein, system 100 can include a data repository 155. An example of data that can be stored in or associated with data repository 155 is described with regard to FIG. 2 and FIG. 3. FIG. 2 depicts example data stored in computing device memory 200.

Example data can include request identifier 205, user preferences 210, candidate couriers 215, drop-off location 220, or merchant data 225. Merchant data 225 can include data associated with merchant A 230 and data associated with merchant B 260.

Request identifier 205 can be a request identifier associated with the service request. This can include a grocery delivery request, a retail item delivery request, a user transportation request, a food delivery request, etc. Request identifier 205 can be associated with service request data. Service request data can include a plurality of items in an order. For instance, the computing system can obtain data indicative of a service request including a request for at least a first item (e.g., item identifier milk) and a second item (e.g., item identifier eggs) to be transported to a destination location (e.g., drop-off location 220).

User preferences 210 can include preferences associated with the user indicative of preferences on brands, cuisine, time of orders, quantity of orders, vehicle type, vehicle level (e.g., luxury, comfort), delivery timing/priority, or any other data associated with a user preference. The user preference 210 can be accessed based on metadata included in the service request such as an encrypted identifier associated with the user that allows the operations computing system 135 to access data for the particular user (e.g., from stored user profile).

Candidate couriers 215 can include data indicative of a plurality of candidate couriers available to facilitate completion of one or more current or future service requests.

For instance, candidate couriers 215 can include data associated with a current number of active couriers within a geographic area. Candidate couriers 215 can include information about each respective courier. For instance, candidate couriers 215 can include data indicative of preferences of respective couriers, location of respective couriers, and the like. Drop-off location 220 can include data indicative of a destination location for the items associated with the grocery delivery service request to be dropped off by one or more couriers or users to be transported for a transportation service.

Merchant data 225 can include data associated with a plurality of merchants (e.g., merchants 115). For instance, merchant data 225 can include data associated with merchant A 230 and data associated with merchant B 260. The data associated with merchant A 230 can include a location 235 of merchant A 230, inventory 240 of items offered by merchant A 230, hours 245 of merchant A 230, an estimated time to pack 250 items at merchant A 230, or other information. Data associated with merchant B 260 can include a location 265 of merchant B 260, inventory 270 of items offered by merchant B 260, hours 275 of merchant B 260, an estimated time to pack 280 items at merchant B 260, or other information. Location 235 and location 265 can include data indicative of a location of the merchant (e.g., geographic location, GPS coordinates, latitude and longitude). Inventory 240 and inventory 270 can include a listing of item identifiers and the quantity of items (e.g., as depicted in 240A-D and 270A-D). Estimated time to pack 250 and 280 can include an average time it takes to pack the item (e.g., for a merchant or courier to obtain the item and check out at a store). Time to pack 250 and 280 can include a time to physically find an item or can include time to prepare an item (e.g., cooking time, preparation time). Estimated time to pack 250 and 280 can vary for item identifiers based on merchant. For instance merchant A 230 can be associated with time to pack 250A-250D and merchant B 260 can be associated with time to pack 280A-280D. For instance, in some merchant locations, produce may be located right near the entrance, whereas in alternative merchant locations, produce is located in the back of the store. Thus, the estimated time to pack 250 and 280 can be indicative of an average time to pack determined by the computing system (e.g., system 100, network system 130, or operations computing system 135).

FIG. 3 depicts example data stored in computing device memory 300 and 350. Computing device memory 300 can store, for example, data indicative of service request parameters (e.g., associated with service request 137). The data indicative of service request parameters can include request identifier 305, order size 310, batch size 315, hyperbatching parameter 320, item weight 325, item size 330, service quality 335, service requirements 340, service metrics 345, and/or product type 348. Additional service request parameters can include the time of day, requested time of arrival of an order/passenger drop-off, the subjectivity level associated with an item (e.g., ripeness for fruit/vegetables, fattiness of meat), the frequency of replacement for a particular item, difficulty of reaching a location, or other parameters. The request identifier 305 can be a unique identifier (e.g., a numerical identifier) associated with a particular service request (e.g., for indexing or cataloging a plurality of service requests). The order size 310 can be indicative of a number of items in a service request. The batch size 315 and hyperbatching parameter 320 can indicate data associated with hyperbatching a plurality of service requests for improved efficiency. For example, the hyperbatching parameter 320 can be an indicator of whether the order/request is eligible for (or has been assigned to) a hyperbatched assignment for a courier—e.g., an assignment that includes a larger number of orders to be retrieved in at least a partially sequential manner (before any are delivered), and then delivered, in at least a partially sequential manner. The hyperbatching parameters 320 could be expressed in a binary manner or with certain values/statuses indicating whether or not the order is eligible for hyperbatching and/or whether it has been assigned to a hyperbatched assignment. The batch size 315 can indicate the number of orders that have been batched together for a batched assignment.

The item weight 325 can be a weight of items in a service request. Additionally or alternatively, in some implementations, the item weight 325 can be a maximum item weight, such as a weight of a heaviest item in a service request. An item size 330 can be a size of items in a service request. Additionally or alternatively, in some implementations, the item size 330 can be one or more dimensions of a largest item in a service request. Additionally or alternatively, in some implementations, the item size 330 can be an approximate size (e.g., size relative to a vehicle class, such as indicating whether the item fits within a given class of vehicles). The service quality 335 can indicate a tiered service, such as hand delivery services, installation services, priority delivery, or other similar service qualities. The service requirements 340, if they exist for a given request, can include service request requirements such as no-contact delivery, stair usage, elevator usage, loading dock usage, or other similar delivery service requirements, based on the specific circumstances of the service request. The service metrics 345 can indicate other metrics associated with a service request such as, for example, a requested time of arrival, specific delivery instructions (e.g., leave at the door/reception desk). The product type 348 can indicate a type of product to be delivered (e.g., groceries, food, electronics, pharmaceuticals, cosmetics, furniture, equipment, and so on).

The computing device memory 350 can store complexity scores respective to a given service type. For instance, each type of service can have an associated complexity score, which may be precomputed and stored in the computing device memory 350. The complexity score may be determined based on perceived difficulty or complexity associated with a given type of service and/or algorithmically determined (e.g., based on service parameters, time requirements, and/or other suitable factors). As examples, the computing device memory 350 can store complexity scores associated with food delivery 355, courier-packed retail delivery 360, merchant-packed retail delivery 365, courier-packed grocery delivery 370, merchant-packed grocery delivery 375, and/or any other suitable service types.

By way of example, the complexity scores of computing device memory 350 may be utilized in computing a complexity score associated with a given service request. As one example implementation, the computing device memory 350 may function as a lookup table defining a relationship between an input parameter (e.g., a service type) and an output score (e.g., the associated complexity score).

The computing device memory 350 may define an algorithmic relationship between a service type and a complexity score. For example, the complexity score for a grocery delivery service may be computed using a weighted function. The weighted function may apply a weight to each specific service parameter based on how much that service parameter contributes to the complexity of performing that type of service. The complexity score (CS) for a grocery delivery service may be computed using the following equation: CS=W1SP1+W2SP2+WnSPn. where W1 is a weighted value (e.g., between 0 and 1) applied to a first service parameter value (SP1), W2 is a weighted value (e.g., between 0 and 1) applied to a second service parameter value (SP2), and Wn is a weighted value (e.g., between 0 and 1) applied to an nth service parameter value (SPn).

By way of example, a user may submit a service request for a grocery delivery service. A computing system may parse the service request to identify a plurality of service parameters. The service parameters can be assigned values for computing a complexity score using the weighted function. The user's service request for a grocery delivery service may include: the courier picking twenty (20) items at the grocery store, where five (5) of the items (e.g., 3 fruits and 2 vegetables) include a level of subjectivity, and 2 of the items (e.g., popular sunscreen, popular yogurt) frequently require replacements. A first service parameter SP1 may indicate that the service is a courier-pick grocery service with a value of 1.0. For context, a merchant-pick grocery service may instead have a value of 0.5. A second service parameter SP2 may indicate the number of items in the requested order. SP2 may be assigned a value of 20.0, representing the twenty items in the order. A third service parameter SP3 may indicate the number of items that include a subjective judgment by the courier when retrieving the items. SP3 may be assigned a value of 5.0, representing that five items include a level of subjectivity. A fourth service parameter SP3 may indicate the number of items that more frequently require a replacement item (e.g., due to the item being out-of-stock). SP4 may be assigned a value of 2.0, representing that the order includes two items that are frequently replaced.

Other service parameters may be parsed for the grocery delivery service. This can include a time of day (e.g., where a higher value is assigned for a time period associated with high levels of traffic or store occupancy), the difficulty or ease of traversing the delivery route, the difficulty reaching the destination where the groceries are to be delivered, the size/weight of the grocery items, etc.

To compute the complexity score, weights can be assigned for each of the determined service parameters. The various respective weights, included in the weighted function, may weigh the different respective service parameters based their level of contribution to the overall complexity of the service request. For example, W3 (the weight applied to SP3 indicating the subjectivity level) and W4 (the weight applied to SP4 indicating the items likely to face replacement) may be higher than W2 (the weight applied to SP2 indicating the overall number of items) because the level of subjectivity and/or the number of potential of replacement items needed may be considered factors that increase the complexity of a service request more than the overall number of items.

The weights applied to a particular service parameter may be static or dynamic. For example, a look-up table can include predetermined weights for each type of service parameter. Each service type (e.g., mobility, restaurant food delivery, retail delivery, grocery delivery) may include a look-up table that stores the pre-determined weight for respective service parameters associated with that service type. The pre-determined weights may be changed by adjusting the assigned value in a field of the data structure. The weights may be considered “static” in that the values applied to a given service parameter do not change based on the specific service request.

The weights can be dynamically changed for a given service request or based on the individual courier. For example, the weight afforded to a particular service parameter for a certain time of day may be changed based whether the occupancy level of the store is estimated to be higher or lower during that time. The weight afforded to item subjectively may be increased when the grocery store is crowded to reflect the difficulty of trying to determine an appropriate ripeness level for a requested fruit, when there are many other patrons in the store. In another example, the weight applied to a service parameter indicating the number of items in an order, may be increased for a courier that has indicated that they are recovering from a health circumstance that limits the amount a courier may personally carry.

After parsing the service request into one or more service parameters and assigning the weights, the complexity score can be computed. This can include, for example, a summation of the products of the values assigned to the respective service parameters and their associated weights (e.g., CS=W1SP1+W2SP2+W3SP3+W4SP4). A higher complexity score can indicate a more complex service request for a courier to perform. A lower the complexity score can indicate a less complex service request for a courier to perform.

While the above example describes computing a complexity score for a grocery delivery service, a similar process can be performed for other service types. For instance, complexity scores can be computed for a mobility service, retail delivery service, or restaurant food delivery service by parsing the service request into service parameters, determining the weights to apply to each service parameter, and computing the complexity score by summing the individual weight-service parameter products (WnSPn).

As described herein, the different service types may include different service parameters. For example, a mobility service may include different service requirements than a restaurant food delivery service. A mobility service may include a pooling parameter indicating the number of riders that will be transported in the vehicle (a portion of which concurrently travelling) while a delivery service may include a batch size 315 indicating the number of food orders that may be batched together (for concurrent transport) or an item size 330 indictive of the size of, for example, a retail item for delivery.

Additionally, or alternatively, a service parameter that is common across two different service types may be weighted differently. For example, a service parameter indicating route complexity may have a lower weight for a delivery service that has a longer time window for the courier to deliver the items (e.g., non-perishable items) than for a mobility service with a passenger that has a more specifically expected ETA.

In some implementations, the complexity score may be computed using one or more machine-learned models. In an example, the machine-learned models may include an unsupervised or a supervised learning model. The machine-learned models may include neural networks (e.g., deep neural networks) or other types of machine-learned models, including non-linear models and/or linear models. Neural networks may include feed-forward neural networks, recurrent neural networks (e.g., long short-term memory recurrent neural networks), convolutional neural networks or other forms of neural networks. Some example machine-learned models may leverage an attention mechanism such as self-attention. For example, some example machine-learned models may include multi-headed self-attention models (e.g., transformer models).

In an aspect of the present disclosure, the machine-learned models may use a variety of types of input data. For example, the input data may include the service request and the machine-learned model may be trained to parse the service request into service parameters. In some implementations, the service request may be pre-processed to parse out the service parameters associated with the service request. The service parameters may be provided as input data into a machine-learned model.

The machine-learned models may be trained to process the service parameters and calculate a complexity score for the service request based on the type of service and the service parameters. For example, a machine-learned model may be trained based on labeled training data indicating the complexity scores for training service requests. The machine-learned model may be trained over time as couriers provide feedback regarding the complexity and difficultly of certain service types and service requests. The hyperparameters and weights of the machine-learned model may be updated based on the re-training and feedback data.

In an embodiment, the one or more machine-learned models may be received from a server over a network, and stored in the computing system implementing the model during run-time. Additionally, or alternatively, one or more machine-learned models may be included in or otherwise stored and implemented by the server that communicates with the implementing computing system according to a client-server relationship. For example, a machine-learned model may be implemented by the server as a portion of a web service. Thus, the one or more machine-learned models may be stored and implemented at the runtime computing system and/or one or more machine-learned models may be stored and implemented at the server computing system.

In some implementations, the complexity score computed for a service request may be the complexity score that is stored in the computing device memory 350. For instance, a set complexity score may be utilized for any service request of a given service type. Alternatively, in some implementations, the complexity score computed for a service request may be modified based on other service parameters of the service request, such as the service parameters 305-348 in computing device memory 300 or other suitable service parameters.

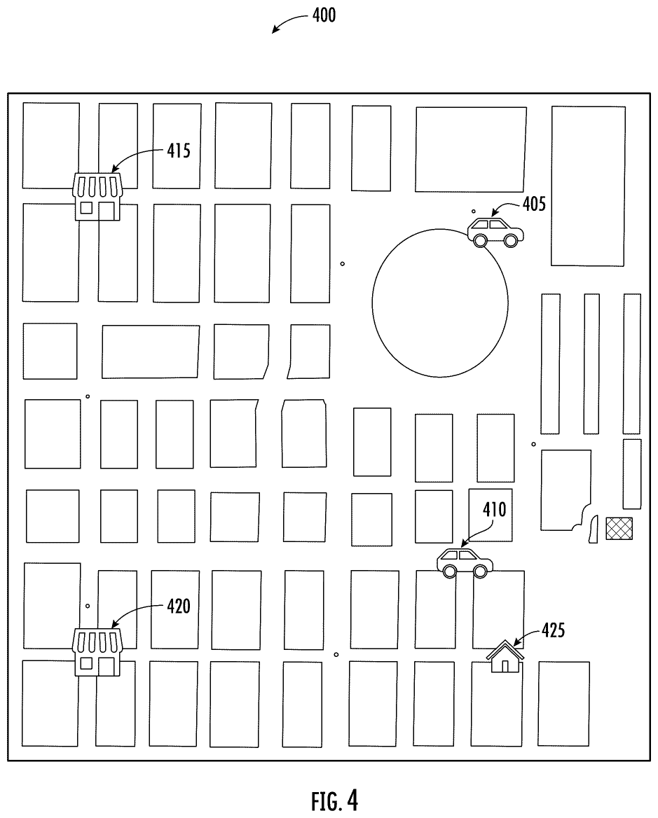

FIG. 4 depicts an example geographic area 400 according to example embodiments of the present disclosure. As depicted in FIG. 4, geographic area 400 can include a location associated with first courier 405, a location associated with second courier 410, a first merchant location 415, a second merchant location 420, and a destination location 425. A computing system according to example aspects of the present disclosure can coordinate service requests between a plurality of candidate couriers to improve courier efficiency, confidence, and opportunities as described further herein.

For instance, the first courier 405 can be closer to the first merchant 415 and the second courier 410 can be closer to the second merchant 420. The computing system can receive a first service request from a user at location 425 and a second service request from a user (e.g., another user or the same user) at the location 425. The first service request can request items from the first merchant 415 by a first service type (e.g., a food delivery service type) and the second service request can request items from the second merchant 420 by a second service type (e.g., a courier-packed retail delivery service type). It may appear that the first courier 405 should be assigned to the first service request and the second courier 410 should be assigned to the second service request based exclusively on the distances between the merchants 415, 420 and the couriers 405, 410. However, according to example aspects of the present disclosure, a computing system can select a courier for a given service request based on courier-level features, such as service count, selection of alternate verticals (e.g., ridesharing, grocery delivery, retail delivery, food delivery), etc., and complexity scores associated with the service request, as described further herein.

By way of example, in some implementations, the computing system can compute a complexity score associated with each service request based on the service type and the one or more service parameters. For instance, because the first service request is a food delivery service, the first service request may have a first complexity score associated with the food delivery service type. The second service request, a courier-packed retail delivery service, may have a second complexity score associated with the courier-packed retail delivery service type. For instance, the second service request may involve more complicated actions by the courier than the first service request, contributing to a higher complexity score.

For each service request, the computing system can select a courier of a plurality of candidate couriers based on the complexity score associated with the service request. For example, in some implementations, to select the courier, the computing system can associate the selected courier and the service request based on the courier-level features associated with the first courier and the complexity score.

As one particular example, in some implementations, the computing system can access courier data associated with each of the first courier and the second courier. The courier data can describe values of these courier-level features associated with each courier. For instance, if the courier-level feature is service count, the courier data of the first courier 405 can indicate service count for the first courier 405 and/or the courier data of the second courier 410 can indicate service count for the second courier 410. The first courier 405 may have a greater service count than the second courier, and may therefore be preferable to perform the more complex second service request. The computing system may therefore select the first courier 405 to perform the second service request and the second courier 410 to perform the first service request, even if a purely distance-based analysis would indicate that it is more optimal for the first courier 405 to perform the first service request.

By way of example, one particular approach by which a computing system may select a courier for a service request based on a complexity score associated with the service request is based on a comparison of the complexity score associated with the service request to a complexity threshold associated with the courier.

The complexity threshold for an individual courier may be based on the experience of the courier (e.g., the number of service requests performed), the service types performed, the complexity scores of the previously completed service requests, and the rating/performance of the courier for the previous completed service requests. For example, the complexity threshold (Ct) for a given service type for a courier may be equal to the highest complexity score of a previously completed service request (of the same or different service type), plus an additional complexity buffer (Ct+X). The size of the additional buffer (X) may be proportional to the rating that the courier has received on the most complex service requests completed by the courier. For example, the additional buffer may be greater when the courier has received higher ratings for those more complex services or smaller when the courier has received lower ratings for those more complex services. This can allow the courier to continue to improve the courier's opportunity to be assigned service requests with higher levels of complexity, while maintaining quality service for the customer.

The computing system can verify that the complexity score is within the complexity threshold (e.g., a maximum complexity) that the courier can handle. For instance, the computing system can access courier data associated with the courier (e.g., the first courier 405). The first courier data associated with the first courier 405 can describe values of one or more courier-level features associated with the first courier 405. The computing system can then compute a complexity threshold associated with the first courier 405 based on the first courier data. The computing system can select the first courier 405 from a plurality of candidate courier (e.g., including the second courier 410) based on the complexity score associated with the service request.

As one example, the complexity threshold may be computed based on an “unlock” schema, where the complexity threshold is raised to a higher complexity tier of service request types once a courier has completed a number of service requests (including service requests of lower-complexity verticals or types). As one particular example, a new courier may only have a first complexity threshold that is satisfied by one or more lowest-complexity service types (e.g., food delivery). After completing a number of those lowest-complexity service requests such that the service count of the courier exceeds a first service count threshold, the computed complexity threshold of the courier may be raised to a second value that is higher than the first complexity threshold, based on the comparison between the service count and the first service count threshold. This second value may be such that the complexity threshold of the courier is satisfied by a second complexity tier of service types (e.g., merchant-packed goods or retail delivery, merchant-packed grocery delivery).

Similarly, after completing a second number of service requests such that the service count of the courier exceeds a second service count threshold, the computed complexity threshold of the courier may be raised to a third value that enables assignment of a third complexity tier of service types (e.g., courier-packed goods or retail delivery, courier-packed grocery delivery).

As another example, the computing system can adjust a time estimate indicative of the expected time for a courier to complete a service request based on values of courier-level features (e.g., service count) associated with the courier. The courier can be selected based on the adjusted time estimate. For instance, if the system is configured to select a courier from a plurality of candidate couriers with the lowest expected time to complete the service request, the adjusted time estimate may be used (e.g., in place of an objective time estimate) in selecting the courier.

Although referred to as a “time estimate,” the time estimate may not necessarily be expressed in units of time (e.g., minutes, hours, etc.). For instance, the time estimate may be expressed as a unitless score or currency, as well as distance (e.g., meters, miles, etc.), fuel cost, or other suitable form by which a plurality of candidate couriers may be ranked and selected. For instance, in one example implementation, the time estimate may be based on a distance estimate indicative of an expected distance traveled by the courier in completing a service request. Distance between locations (e.g., between the merchants 415, 420 and the location 425) can be represented in a plurality of forms including, a physical distance measurement (e.g., mile, kilometers, haversine distance, distance traveled) or a time measurement (e.g., seconds, minutes). The distance can be static (e.g., a haversine distance) or can be dynamic (e.g., distance traveled, time). A dynamic distance can take into account real-time conditions (or near-real-time conditions) that can include weather, traffic, or courier supply.

By way of example, the computing system can compute a time estimate for the courier to complete the service request based on the service type and the one or more service request. In some implementations, for example, this time estimate may be based on data associated with the service request itself and/or external factors (e.g., traffic congestion, weather, etc.). This time estimate may be courier-agnostic to information associated with a particular courier, such as the values of courier-level features. The computing system can compute an adjusted time estimate by adjusting the time estimate based on the courier data. For example, the adjusted time estimate may be decreased if the courier data indicates that the courier is highly experienced, which may indicate that the courier can complete the service request in less time than a courier with an average number of experience.

As one example, in some implementations, the one or more courier-level features can include historical service data. The historical service data can include any suitable information about previous service requests assigned to and/or fulfilled by a courier. For example, the historical service data can indicate service counts or trip counts, which may be respective to a particular service type of a plurality of service types. As another example, the historical service data can include complexity scores associated with previous service requests, customer reviews of the courier, completion times associated with previous service requests, acceptance rate, historical service parameters, and other historical service data. In some implementations, the historical service data may be aggregated over a subset of all previously assigned service requests, such as a subset of most recently assigned service requests (e.g., the previous 50, 100, 200, etc. service requests).

In some implementations, the adjusted time estimate can be computed (e.g., adjusted) based on the historical service data. As one example, if the historical service data indicates that a service count (e.g., respective to a given service type or aggregated for multiple or all service types) is above a service count threshold associated with a time adjustment, the adjusted time estimate can be computed by applying the time adjustment to the time estimate to arrive at the adjusted time estimate. As another example, in some implementations, the adjusted time estimate can be computed (e.g., adjusted) based on a comparison of the historical complexity scores associated with previous service requests of the courier to the complexity score of a present service request. For example, in some implementations, the computing system can determine that a historical complexity score, such as an average, mean, median, or other aggregation of complexity scores of one or more prior service requests, is greater than or less than the complexity score of the present service request. In response to determining that the historical complexity score is greater than the complexity score of the present service request, the adjusted time estimate can be decreased relative to the time estimate. Additionally or alternatively, in response to determining that the historical complexity score is less than the complexity score of the present service request, the adjusted time estimate can be increased relative to the time estimate.

As yet another example, in some implementations, a service count of a service type having a lower base complexity can be used to gauge readiness for a courier to handle service types having a higher base complexity. For instance, in some implementations, selecting a courier to be assigned to a service request of a first service type can include accessing a service count of a second service type in the historical service data of the courier. For instance, the first service type and/or the second service type can be service types of a plurality of service types that the delivery service (e.g., the application 112) is equipped to provide to users, has provided to users, or is planning to provide to users. Each service type can have an associated base complexity. For instance, the base complexity of a service type can be the value of a complexity score for that service type (e.g., as stored in the computing device memory 350 of FIG. 3). In some implementations, the base complexity may be the value of the complexity score for each service request of that service type. In some implementations, the base complexity may be adjusted (e.g., based on service parameters) to arrive at the complexity score for a given service request.

The computing system can compute a service count threshold for the courier and the service request. For instance, the service count threshold can be indicative of a number of services of the second service type to be completed by the courier prior to assigning the courier to service requests of the first service type. As one example, the computing system may compute that a courier needs to complete at least fifty service requests of the second service type (e.g., having a lower base complexity) prior to being assigned a service request of the first service type (e.g., having a higher base complexity). In some implementations, the service count threshold may define a minimum and/or a maximum service count. To compute the service count threshold, in some implementations, the computing system may access a service count threshold lookup function, the lookup function configured to receive a service type and output a service count threshold respective to the service type. As one example, the service count threshold may be stored in a memory of the computing device.

The computing system can then compute that the service count of the second service type of the courier satisfies the service count threshold. For instance, (e.g., if the service count threshold defines a minimum service count), the computing system can determine that the service count of the second service type is greater than (or equal to) the service count threshold. Additionally or alternatively, (e.g., if the service count threshold defines a maximum service count), the computing system can determine that the service count of the second service type is less than (or equal to) the service count threshold. The computing system can select the courier in response to computing that the service count of the second service type satisfies the service count threshold. In some implementations, the service count threshold may be a “soft” threshold. For instance, a first courier who satisfies the service count threshold may be considered over a second courier who does not satisfy the service count threshold when assigning a first service request, but the second courier may be eligible for a second service request of the same type, or may be eligible for the first service request if there are no couriers satisfying the service count threshold that are available.

As yet another example, in some implementations, a courier ranking or tiered courier system can be used to adjust the time estimate. For instance, couriers can be ranked based on courier-level features such as service count. As one example, a courier can progress through a plurality of courier ranks as the courier's ranking score increases. The courier's ranking score can be computed respective to a courier. For instance, the ranking score can be based on a relationship between values of one or more courier-level features, such as service count, efficiency, acceptance rate, timeliness, etc. As one example, the ranking score of a courier may be related to the courier-level feature of service count. The relationship between ranking scores and courier ranks can be defined by an equation, algorithm or a courier rank table. For instance, the courier rank table can indicate a tiered relationship between ranking scores and the plurality of courier ranks. Computing the courier rank of a given courier can be based on a comparison of the ranking score of the courier to the courier rank table, based on the tiered relationship between ranking scores and the plurality of courier ranks. For instance, the courier rank table can be a lookup table configured to receive a ranking score associated with a courier as input and return a courier rank within the plurality of courier ranks associated with the courier based on the ranking score of the courier.

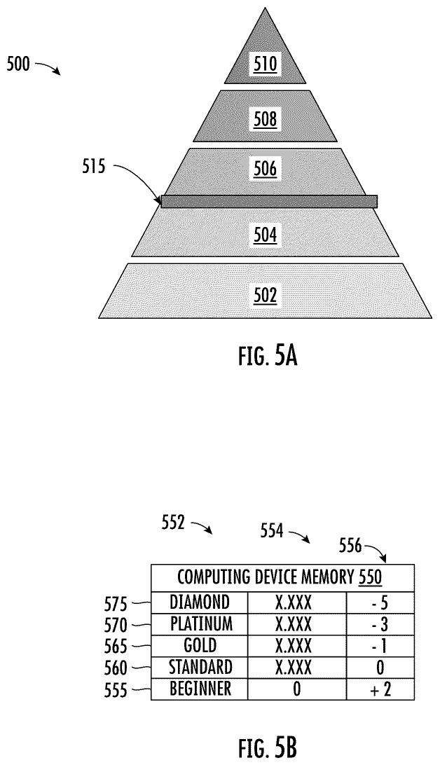

One example depiction of a courier ranking schema is depicted in FIG. 5A-5B. For instance, FIG. 5A depicts a graph 500 of a plurality of courier ranks. The courier ranks can progress from a first courier rank 502 to a top courier rank 510. As depicted in FIG. 5A, the number of couriers at each rank 502-510 may generally decrease at higher ranks. However, in some implementations, the number of couriers at each rank 502-510 may exhibit a different relationship. For instance, in some implementations, the amount of couriers at each rank 502-510 may be about equivalent, or may be greater at a subsequent rank than at a prior rank.

FIG. 5B depicts example data stored in computing device memory 550. The computing device memory 550 depicts values of ranking score thresholds 554 and time modifiers 556 relative to courier ranks 552. The courier ranks 552 can generally, but do not necessarily, correspond to the ranks 502-510 of FIG. 5A. For example, the beginner rank 555 can generally correspond to the first rank 502. Similarly, the standard rank 560 can correspond to the second rank 504, the gold rank 565 can correspond to the third rank 506, the platinum rank 570 can correspond to the fourth rank 508, and/or the diamond rank 575 can correspond to the final rank 510. More, fewer, and/or different courier ranks can be included without departing from the scope of the present disclosure. Each of the ranks 555-575 can have an associated ranking score threshold 554 that indicates a minimum ranking score (or range of ranking scores) that qualifies a courier for a respective rank 555-575. For example, the beginner rank 555 requires a ranking score of zero in the example of FIG. 5B, and may therefore be available immediately to new couriers. The standard rank 560, for example, may be available to couriers after completing a number of service requests to raise their respective ranking scores to at least the ranking score threshold 554 associated with the standard rank 560.

In some implementations, couriers above a certain rank 502-510 may receive consideration when assigning (e.g., higher-complexity) service requests. For example, threshold 515 indicates that couriers ranking at least at the third rank 506 and above can qualify for algorithmic boosting (e.g., by adjusting their respective time estimates positively). As one example, computing an adjusted time estimate for a courier (e.g., the first courier 405) can include computing a first time modifier associated with the courier. The first time modifier can be associated with a courier rank of the courier. The adjusted time estimate can be computed by applying the time modifier to the time estimate for the courier. As one example, to compute the first time modifier, the computing system can access a time modifier table indicating a respective relationship between a plurality of time modifiers and the plurality of courier ranks. The computing system can compute the first time modifier based on a comparison between the courier rank and the time modifier table based on the respective relationship between the plurality of time modifiers and the plurality of courier ranks. For example, the computing system can input the courier rank into the courier rank table and receive a time modifier associated with the input courier rank.

One example time modifier table is depicted by columns 552 and 556 of FIG. 5B. For instance, each of the ranks 555-575 can have an associated time modifier 556. The time modifier 556 (e.g., the values thereof) can be respective to the ranks 555-575. As one example, the beginner rank 555 has a time modifier of +2, indicating that couriers in the beginner rank 555 are likely to experience slight inefficiencies. At higher ranks (e.g., at the platinum rank 570), the courier will receive a time modifier of −3, indicating that the couriers at the platinum rank 570 are likely to provide efficiency savings associated with experience indicated by courier-level features and reflected in the ranking scores of those couriers. The time modifier can therefore provide opportunities for couriers and reward efficiency gains associated with higher service counts and other positive courier-level features. The time modifier may be in any suitable unit, such as minutes, seconds, hours, digital clock cycles, or other suitable units of time.

In some implementations, the modifiers may instead be distance modifiers. For instance, the time estimate for a courier to complete a service request may be based on a distance estimate indicative of distance traveled by the courier in completing the service request. Computing the adjusted time estimate can then include computing a distance modifier associated with a courier ranking of the courier; applying the distance modifier to the distance estimate to produce an adjusted distance estimate; and computing the adjusted time estimate based on the adjusted distance estimate. Similar to the time modifiers described above, the distance modifier can be defined by an equation, algorithm, or table indicating a respective relationship between a courier rank of a plurality of courier ranks and the distance modifier respective to that courier rank. The distance modifier may be in any suitable unit, such as meters, feet, miles, or other suitable units of distance.

Returning now to FIG. 4, in some implementations, the computing system can coordinate multiple service requests among multiple couriers based on courier-level features and respective complexities of the service requests. For instance, in some implementations, the computing system can access courier data associated with one or more couriers (e.g., the first courier 405 and/or the second courier 410), the courier data describing one or more courier-level features associated with the courier(s). The computing system can access first service request data indicative of a first service request. The first service request can have first service parameters and/or a first service type of the first service request. Additionally or alternatively, the computing system access second service request data indicative of a second service request. The second service request can have second service parameters and/or a second service type of the second service request. The second service request may have a different complexity than the first service request (e.g., due to a different service type and/or service parameters).

In some implementations, the computing system can compute compatibility scores between courier(s) and service request(s) based on a comparison between the values of courier-level features for the courier and the service type and/or service parameters of the service request. For instance, the compatibility score may be based on a comparison of a complexity score associated with the service request, a time estimate (e.g., adjusted time estimate) associated with the courier, a readiness score associated with the courier, machine-learning output in response to receipt of the values of courier-level features associated with the courier, and so on. As examples, the computing system can compute a first compatibility score between the courier(s) (e.g., the first courier 405 and/or the second courier 410) and the first service request based on a comparison between the courier-level features associated with the courier(s) and the first service parameters. Additionally or alternatively, the computing system can compute a second compatibility score between the courier(s) (e.g., the first courier 405 and/or the second courier 410) and the second service request based on a comparison between the courier-level features associated with the courier(s) and the second service parameters. Based on comparisons between the compatibility score(s) of the courier(s) and service request(s), the computing system can coordinate service requests between the couriers. As one example, if the first courier 405 has a higher compatibility score with the second service request (e.g., from the second merchant 420) than the first service request (e.g., from the first merchant 415), the computing system can assign the second service request to the first courier 405. The computing system may additionally assign the first service request to the second courier 410.

A compatibility score can be computed based on the previous services requests completed by the courier, the complexity scores of those service requests, and/or the courier's complexity score threshold. The higher the compatibility score, the more compatible the courier may be for the associated service request. For example, the compatibility score may be higher in the event that the courier has completed services of a similar type or with similar service parameters and/or with similar levels of complexity.

Even if the courier has not completed service requests of the same type, the previous experience of the courier can be interpolated to compute the compatibility score. For example, a mobility service that includes a high number of pooled riders with a similar complexity score may be interpolated to determine a compatibility score that indicates that the courier is suitable for a batched delivery service that includes a high number of order pick-ups and deliveries (similar in nature to the pick-up and drop-offs of the pooled mobility service). Additionally, or alternatively, the compatibility score can be increased in the event the complexity score of the service request is within the complexity score threshold of the courier. In this way, the opportunities for a given courier can be improved, even if the courier lacks experience in the specific vertical/service type of the current service request.

Once the first courier 405 is selected, the computing system can output first instructions to a first courier device (e.g., courier device 110A associated with courier 106A) associated with the first courier 405. The first instructions are executable (e.g., can be executed) by the first courier device to cause a service assignment to be provided for display via a user interface of the first courier device (e.g., via application 112 via courier device 110A).

The service assignment can indicate the first courier 405 is to perform the service request. For instance, if the service request is a delivery service from the second merchant 420 to the location 425, the computing system can determine a route for the first courier 405 from a current location of the first courier 405 the second merchant 420 and from the second merchant 420 to the location 425. The first service assignment can indicate the first courier 405 is to transport the first item from the second merchant 420 to the location 425. Additionally or alternatively, the first instructions may include additional information about the service request, such as distance, estimated time, service type, payment, an item list, or other suitable information (e.g., service parameters).

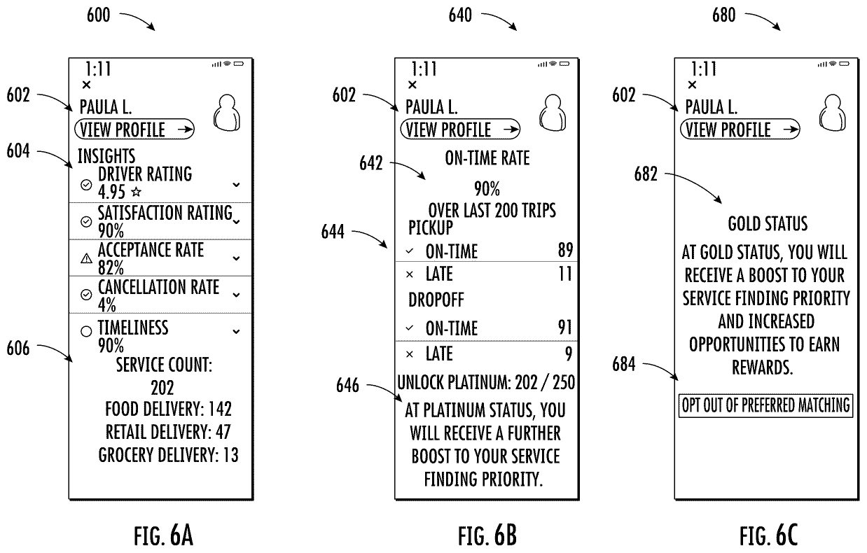

FIGS. 6A through 6C depict example user interfaces providing courier-level feature information according to example embodiments of the present disclosure. For instance, FIG. 6A depicts an example user interface 600. The user interface 600 may be presented to a courier on a service application (e.g., application 112 of FIG. 1). The user interface 600 can include a courier information element 602. The courier information element 602 can display information about a courier, such as the courier's name, account number, city, or other information. In some implementations, the courier may interact with the courier information element 602 to cause the user interface 600 to display additional information or options associated with the courier's information (e.g., by redirecting to another interface and/or by loading additional interface elements). The courier information element 602 may, in some implementations, be static as the courier navigates through the interface 600 (e.g., to interfaces 640 or 680).

The interface 600 can additionally include an insights element 604. The insights element 604 can display values of certain courier-level features associated with the courier.

As one example, the computing system can output data indicative of courier-level features, such as service count, courier rank, rating, acceptance rate, cancellation rate, timeliness, efficiency, or other courier-level features, to a courier device associated with the courier. The courier device can provide that data for display via the interface 600. In some implementations, the courier can interact with portions of the insights element 604 to display additional information relating to the displayed courier-level features, such as information breakdowns of the courier-level features. As one example, a courier that taps on the “driver rating” portion of the insights element 604 may be presented with a drop-down element showing counts or percentages of ratings by star count. In addition to the insights element 604, the interface 600 includes a service count element 606 that displays a breakdown of the courier's service count respective to service type and in total across all service types.

FIG. 6B depicts another example user interface 640. The interface 640 can be presented by a service application (e.g., the application 112). In some implementations, the courier may navigate to the interface 640 from the interface 600 (e.g., by scrolling or redirecting from the interface 600). The interface 640 includes the courier information element 602. Additionally, the interface 640 includes an on-time element 642. The on-time element 642 indicates the courier's on-time rate (e.g., another courier-level feature) as well as the number of recent trips over which it is counted. For instance, in the example of FIG. 6B, the prior 200 trips contribute to the courier's on-time rate, which suggests that the first two trips of the courier's 202 total trips are not counted in this courier's on-time rate. Element 644 provides a breakdown of on-time versus late pickups and deliveries. Finally, courier rank increase element 646 indicates the requirements that the courier must satisfy to reach the next courier rank of a plurality of courier ranks. In some implementations, the requirements depicted in courier rank increase element 646 may be analogous to the manner in which the computing system determines courier rank, even if not analogously presented. For instance, while the computing system may compute courier rank based on a scoring factor, the contributing features to that score may instead be depicted in the element 646.

FIG. 6C depicts another example user interface 680. The interface 680 can be presented by a service application (e.g., the application 112). In some implementations, the courier may navigate to the interface 680 from the interface 600 or 640 (e.g., by scrolling or redirecting from the interface 600 or 640). The interface 680 includes the courier information element 602. Additionally, the interface 680 includes a courier rank element 682. The courier rank element 682 displays information about the courier's current courier rank and/or information about the boosts provided to the courier at the courier rank. For instance, the computing system can output data indicative of the courier ranking to the courier device. The courier device can display this data via the interface 680. The courier can additionally be provided with an opt out element 684. The courier may interact with the opt out element 684 to opt out of courier-level feature based coordination with service requests. The courier may be treated as a default rank when opted out, for example.

The example user interfaces presented in FIGS. 6A-C help provide transparency of information to a courier and allow the courier to track improvements over time.

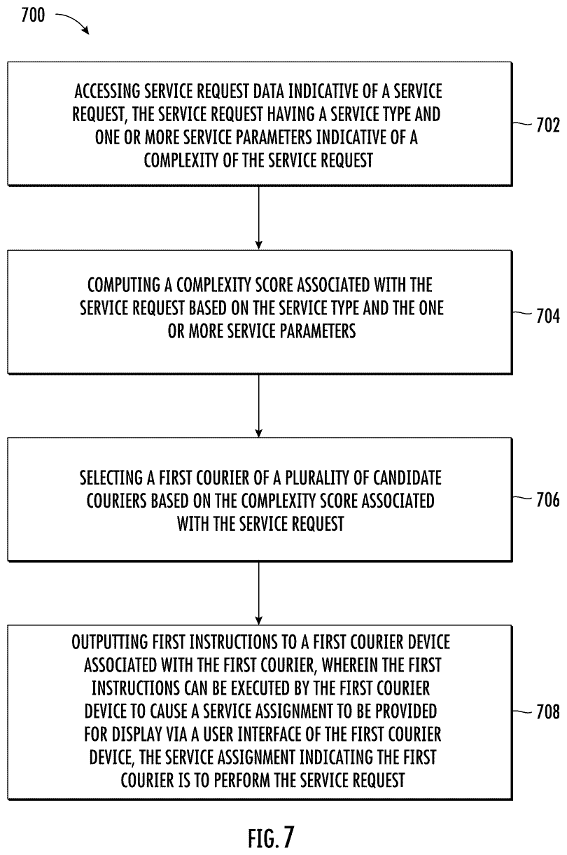

FIG. 7 depicts a flowchart diagram of an example method for complexity-based matching across service verticals. The different service verticals can include different types of service that may be offered via a courier. This can include, for example, a mobility service (e.g., for transporting passengers), a retail delivery service (e.g., for transporting retail goods), a restaurant food delivery service (e.g., for delivering food from a restaurant or other food preparer), a grocery delivery service (e.g., for delivering groceries), etc.

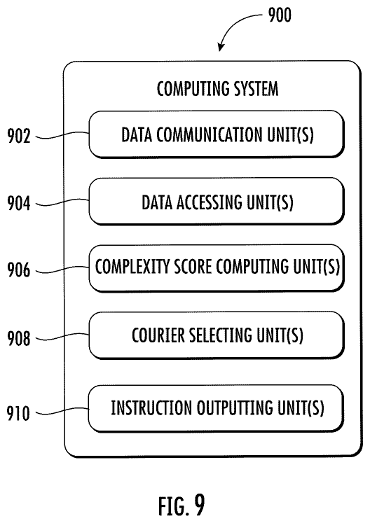

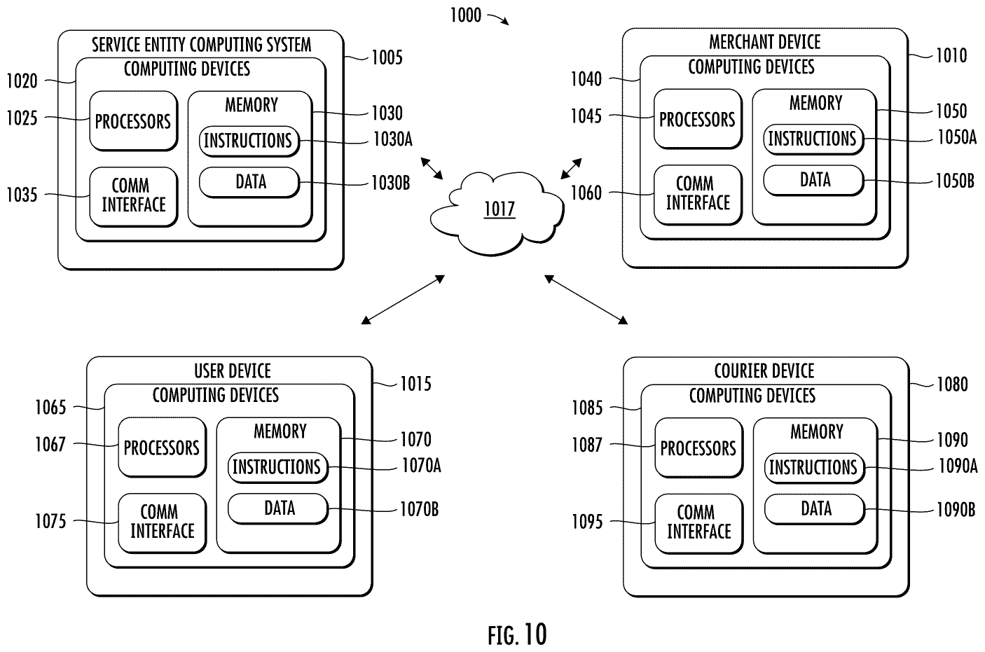

One or more portion(s) of the method 700 can be implemented by one or more computing devices such as, for example, the computing devices/systems described in FIG. 1, FIG. 9, and FIG. 10. Moreover, one or more portion(s) of the method 700 can be implemented as an algorithm on the hardware components of the device(s) described herein (e.g., as in FIG. 1, FIG. 9, and FIG. 10). For example, a computing system can include one or more processors and one or more non-transitory, computer-readable media storing instructions that are executable by the one or more processors to cause the computing system to perform operations, the operations including one or more of the operations/portions of method 700. FIG. 7 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure.

At 702, the method 700 can include accessing service request data indicative of a service request. The service request can have a service type and one or more service parameters. By way of example, a user of a delivery service can initiate a delivery request via a software application running on a user device (e.g., mobile phone). The software application can cause the user device to render a user interface for the user to interact with via a display screen. In an example, the user interface can include an interactive elements that allow for a user to search for and select items and merchants. This can include, for example, selecting grocery items for purchase via a grocery store, selecting food for purchase from a restaurant, selecting merchandise from a retailer, and so on. In some implementations, the one or more service parameters are indicative of at least one of: number of items to be transported, order size, batch size, hyperbatching attribute, item weight, item size, origin, intermediate destination, final destination, service quality, service priority, service requirements, service metrics, or product type. In some implementations, the service type is or includes at least one of: food delivery, courier-packed retail delivery, merchant-packed retail delivery, courier-packed grocery delivery, merchant-packed grocery delivery, o mobility services.

At 704, the method 700 can include computing a complexity score associated with the service request based on the service type and the one or more service parameters. The complexity score can be computed based on the service type (e.g., based on a base complexity associated with the service type) and/or the service parameters (e.g., adjusted from the base complexity based on the service parameters).

As described herein, the complexity score may be computed using a weighted function. The weighted function may apply a weight to each specific service parameter based on how much that service parameter contributes to the complexity of performing that type of service. The complexity score (CS) may be computed using the following equation: CS=W₁SP₁+W₂SP₂+WₙSPₙ . . . where W₁ is a weighted value applied to a first service parameter value (SP₁), W₂ is a weighted value applied to a second service parameter value (SP₂), and Wₙ is a weighted value applied to an n^{th} service parameter value (SPₙ).

Each of the respective services may have various levels of complexity. For instance, a mobility service that includes picking-up a user from an easily accessible origin location and dropping the user at an easily accessible destination location may include a lower complexity score than a mobility service for a user with an origin location and/or destination location that is difficult to reach. In another example, a mobility service with a plurality of users (e.g., a pool of riders) with multiple different origins and/or destinations may include a higher complexity score than a mobility service with a single user. In another example, a time of day may impact the complexity of the mobility service (e.g., at times of higher traffic, when a crowded event is finished). In another example, a mobility service for a crowded event or more dynamic facility (e.g., concert venue, busy airport, etc.) may include a higher complexity.

A retail delivery service may include various complexity scores based on the service parameters. For example, a retail delivery service that includes a higher number of items (e.g., toiletries, laundry soap) may include a higher complexity than a retail delivery service that includes a single item (e.g., cough medicine). A retail delivery service in which the courier shops for the item may include a higher complexity score than if the merchant picks the item and has it ready for the courier. In another example, a retail delivery service in which the retail item is picked by the merchant and ready for the courier may include a lower complexity score than a mobility service that includes a single user.

A grocery delivery service may include various complexity scores depending on the service type and the one or more service parameters. For example, a grocery delivery service in which the merchant shops for and packs the requested groceries may include a higher complexity score than a grocery delivery service in which the courier is responsible for picking the requested grocery items. Additionally, or alternatively, a grocery delivery service with a higher number of requested items may include a higher complexity score than a grocery delivery service with a lower number of requested items. Additionally, or alternatively, a grocery delivery service in which the requested items include item(s) that may have a higher historical frequency of needing replacement items (e.g., due to frequently being out-of-stock) may include a higher complexity score than a grocery delivery score with a lower number of such items. Additionally, or alternatively, a grocery delivery service that includes item(s) with a subjective level of selection (e.g., fruit or vegetable ripeness, meat fattiness) may include a higher complexity score than a grocery delivery service with a lower number of such items.

In some implementations, a grocery delivery service may include a lower complexity score than compared to other types of services. For example, a grocery delivery service in which the merchant shops and packs the grocery items for the courier may have a lower complexity score than a mobility service with an origin/destination that is difficult to access, or that involves multiple passengers with distinction origins/destinations.

At 706, the method 700 can include selecting a first courier of a plurality of candidate couriers based on the complexity score associated with the service request. Selecting the first courier based on the complexity score can be performed in any suitable manner. As one example, in some implementations, selecting the first courier can be based on an adjusted time estimate associated with the first courier. For instance, the method can include computing a first time estimate for the first courier to complete the service request based on the service type and the one or more service parameters. The method can further include computing a first adjusted time estimate by adjusting the first time estimate based on the first courier data. The method can include selecting the first courier based on the first adjusted time estimate.

In some implementations, the one or more courier-level features can include historical service data respective to a plurality of service types. For instance, the service type of the service request can be a first service type of the plurality of service types. Computing the first adjusted time estimate can include adjusting the first time estimate based on the historical service data of the first courier. Furthermore, in some implementations, selecting the first courier for the service request having the first service type (e.g., a courier-packed grocery deliver) can be based on verifying that the first courier has completed a number of service requests of a second service type (e.g., restaurant food delivery with a difficult to access restaurant, pooled mobility services). For instance, the method 700 can include accessing a service count of a second service type of the plurality of service types in the historical service data of the first courier. The second service type can have a second base complexity that is lower than a first base complexity of the first service type. The method 700 can include computing a service count threshold indicative of a number of services of the second service type to be completed by the first courier prior to assigning the first courier to service requests of the first service type. The method 700 can include computing that the service count of the second service type is greater than the service count threshold. The method 700 can include selecting the first courier in response to computing that the service count of the second service type is greater than the service count threshold. In this way, the method 700 can include interpolating the ability of the courier to handle a more complex service, based on the courier's experience with other types of services.

In some implementations, the adjusted time estimate can be computed based on a historical complexity score associated with the historical service data of the first courier. For instance, the method 700 can include computing a historical complexity score associated with the historical service data of the first courier. Adjusting the first time estimate can be based on a comparison of the historical complexity score to the complexity score of the service request. For instance, in some implementations, adjusting the first time estimate can include decreasing the first time estimate if the historical complexity score is greater than the complexity score of the service request.

In some implementations, a fee associated with the service request can be determined based on the adjusted time estimate.

In some implementations, the one or more courier-level features can include a courier rank within a plurality of courier ranks. The method 700 can include computing a first courier rank of the first courier, the first courier rank within the plurality of courier ranks.

Computing the first adjusted time estimate can be based on the first courier rank. For instance, in some implementations, computing the first courier rank can include: accessing data indicative of a ranking score of the first courier; accessing a courier rank table indicating a tiered relationship between ranking scores and the plurality of courier ranks; and computing the first courier rank based on a comparison of the ranking score of the first courier to the courier rank table based on the tiered relationship between ranking scores and the plurality of courier ranks. As another example, in some implementations, computing the first adjusted time estimate can include computing a first time modifier associated with a first courier rank of the first courier and applying the first time modifier to the first time estimate to compute the first adjusted time estimate. Still further, in some implementations, computing the first time modifier can include accessing a time modifier table indicating a respective relationship between a plurality of time modifiers and the plurality of courier ranks and computing the first time modifier based on a comparison between the first courier rank and the time modifier table based on the respective relationship between the plurality of time modifiers and the plurality of courier ranks.

In some implementations, the first time estimate is based on a first distance estimate indicative of distance traveled by the first courier in completing the service request. Computing the first adjusted time estimate can include: computing a first distance modifier associated with a first courier rank of the first courier; applying the first distance modifier to the first distance estimate to produce a first adjusted distance estimate; and computing the first adjusted time estimate based on the first adjusted distance estimate.

In some implementations, selecting the first courier can be based on a comparison between the (e.g., adjusted) time estimate of the first courier and time estimates of the plurality of candidate couriers. For instance, in some implementations, the method 700 can include accessing second courier data associated with a second courier (e.g., of the plurality of candidate couriers). The second courier data can describe values of the one or more courier-level features associated with the second courier. The method 700 can include computing a second time estimate for the second courier to complete the service request based on the service type and the one or more service parameters. Selecting the first courier can be based on a comparison between the first adjusted time estimate and the second time estimate.

In some implementations, selecting the first courier can include associating the first courier and the service request based on a comparison of the complexity score associated with the service request to a complexity threshold associated with the first courier. For instance, the method 700 can include accessing first courier data associated with the first courier. The first courier data can describe values of one or more courier-level features associated with the first courier. The method 700 can include computing a complexity threshold associated with the first courier based on the first courier data.

At 708, the method 700 can include outputting first instructions to a first courier device associated with the first courier. The first instructions can be executed by the first courier device to cause a service assignment to be provided for display via a user interface of the first courier device. The service assignment can indicate that the first courier is to perform the service request. In some implementations, the method 700 can further include outputting data indicative of the first courier rank to the first courier device.

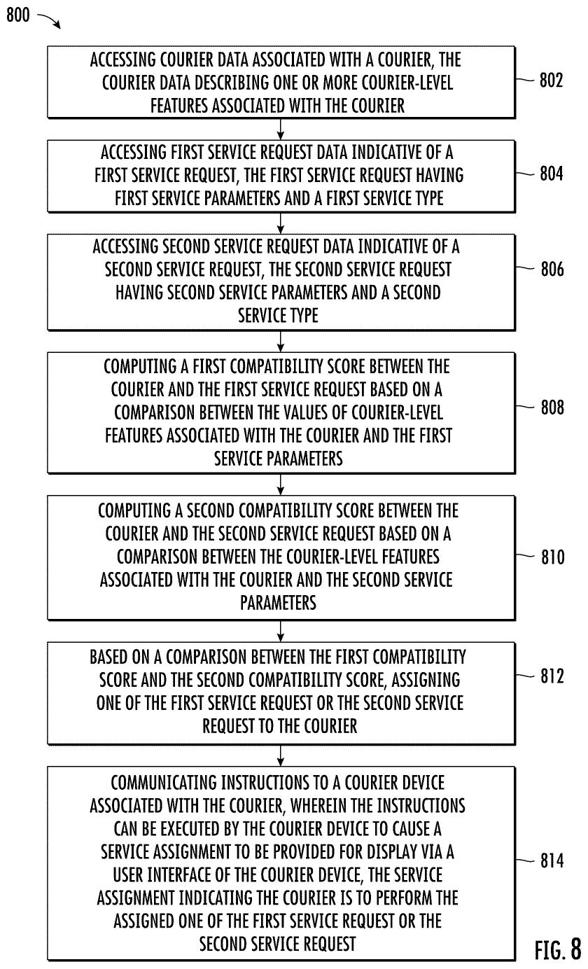

FIG. 8 depicts a flowchart diagram of an example method for complexity-based matching across service verticals. One or more portion(s) of the method 800 can be implemented by one or more computing devices such as, for example, the computing devices/systems described in FIG. 1, FIG. 9, and FIG. 10. Moreover, one or more portion(s) of the method 800 can be implemented as an algorithm on the hardware components of the device(s) described herein (e.g., as in FIG. 1, FIG. 9, and FIG. 10). For example, a computing system can include one or more processors and one or more non-transitory, computer-readable media storing instructions that are executable by the one or more processors to cause the computing system to perform operations, the operations including one or more of the operations/portions of method 800. FIG. 8 depicts elements performed in a particular order for purposes of illustration and discussion. Those of ordinary skill in the art, using the disclosures provided herein, will understand that the elements of any of the methods discussed herein can be adapted, rearranged, expanded, omitted, combined, or modified in various ways without deviating from the scope of the present disclosure.

At 802, the method 800 can include accessing courier data associated with a courier. The courier data can describe one or more courier-level features associated with the courier. The courier-level features can be, for example, service count, courier rank, rating, acceptance rate, cancellation rate, timeliness, efficiency, or other courier-level features. Accessing this data can include performing a look-up function for a data structure storing such data, generating a search query for a searchable database (e.g., storing courier profiles), etc.

At 804, the method 800 can include accessing first service request data indicative of a first service request. The first service request can have first service parameters and/or a first service type. For example, the first service request may include a grocery delivery service in which the courier is to pack five grocery items, none of which include a level of subjectivity or a high frequency of replacement. Accessing this data can include performing a look-up function for a data structure storing such data, generating a search query for a searchable database (e.g., a service request queue), etc.

At 806, the method 800 can include accessing second service request data indicative of a second service request. The second service request can have second service parameters and/or a second service type, which may be different from the first service parameters and/or the first service type. For example, the second service request may include a grocery delivery service involving a plurality of perishable items, in which the courier is responsible for picking the items and at least a portion of the items (e.g., fruits and vegetables) include a level of subjectivity for the courier (e.g., ripeness) and one or more of the items include a high frequency of replacement (e.g., popular sunscreen during summer time). Accessing this data can include performing a look-up function for a data structure storing such data, generating a search query for a searchable database (e.g., a service request queue), etc.

At 808, the method 800 can include computing a first compatibility score between the courier and the first service request based on a comparison between the courier-level features associated with the courier and the first service parameters. As described herein, the first compatibility score can indicate the appropriateness of the courier to be assigned the first service request. For example, the courier may not have historically performed any grocery delivery services but may have performed numerous complicated mobility services in which the origins/destinations are difficult to reach or that included a plurality of concurrent passengers with various respective origins/destinations. The courier may include an overall high rating for such services.

At 810, the method 800 can include computing a second compatibility score between the courier and the second service request based on a comparison between the courier-level features associated with the courier and the second service parameters. As described herein, the second compatibility score can indicate the appropriateness of the courier to be assigned the second service request (e.g., the more complex grocery delivery service).

At 812, the method 800 can include, based on a comparison between the first compatibility score and the second compatibility score, assigning one of the first service request or the second service request to the courier. For example, the first compatibility score (e.g., for the less complex grocery delivery service) may be higher than the second compatibility score (e.g., for the more complex grocery delivery service) because the courier may not have performed any grocery delivery services to date. However, based on the courier's previous experience performing the complicated mobility services, a computing system may interpolate the courier would be appropriate for the grocery delivery service, with less complexity. This allows the courier to be provided with an opportunity within a new service vertical, with a complexity level that is likely to allow the courier to be successful, while also expanding courier's earning potential.

At 814, the method 800 can include communicating instructions to a courier device associated with the courier. The instructions can be executed by the courier device to cause a service assignment to be provided for display via a user interface of the courier device. The service assignment can indicate that the courier is to perform the assigned one of the first service request or the second service request.

Various means can be configured to perform the methods and processes described herein. For example, FIG. 9 depicts an example computing system 900 that includes various means according to example embodiments of the present disclosure. The computing system 900 can be or otherwise include, for example, an operations computing system, etc. The computing system 900 can include data communication unit(s) 902, data accessing unit(s) 904, complexity score computing unit(s) 906, courier selecting unit(s) 908, instruction outputting unit(s) 910 or other means for performing the operations and functions described herein. In some implementations, one or more of the units can be implemented separately. In some implementations, one or more units can be a part of or included in one or more other units. These means can include processor(s), microprocessor(s), graphics processing unit(s), logic circuit(s), dedicated circuit(s), application-specific integrated circuit(s), programmable array logic, field-programmable gate array(s), controller(s), microcontroller(s), or other suitable hardware. The means can also, or alternately, include software control means implemented with a processor or logic circuitry for example. The means can include or otherwise be able to access memory such as, for example, one or more non-transitory computer-readable storage media, such as random-access memory, read-only memory, electrically erasable programmable read-only memory, erasable programmable read-only memory, flash/other memory device(s), data registrar(s), database(s), or other suitable hardware.

The means can be programmed to perform one or more algorithm(s) for carrying out the operations and functions described herein. For instance, the means (e.g., data communication unit(s) 902) can be configured to communicate data indicative of a request for a courier to perform a delivery service.

In addition, the means (e.g., data accessing unit(s) 904) can be configured to access service request data indicative of a service request. For example, the service request can have a service type and one or more service parameters.

In addition, the means (e.g., complexity score computing unit(s) 906) can be configured to compute a complexity score associated with the service request based on the service type and the one or more service parameters.

In addition, the means (e.g., courier selecting unit(s) 908) can be configured to compute a complexity score associated with the service request based on the service type and the one or more service parameters.

In addition, the means (e.g., instruction outputting unit(s) 910) can be configured to output first instructions to a first courier device associated with the first courier. For example, the first instructions can be executed by the first courier device to cause a service assignment to be provided for display via a user interface of the first courier device. The service assignment can indicate that the first courier is to perform the service request.

These described functions of the means are provided as examples and are not meant to be limiting. The means can be configured for performing any of the operations and functions described herein.

FIG. 10 depicts a block diagram of an example system 1000 for implementing systems and methods according to example embodiments of the present disclosure. The example system 1000 illustrated in FIG. 10 is provided as an example only. The components, systems, connections, or other aspects illustrated in FIG. 10 are optional and are provided as examples of what is possible, but not required, to implement the present disclosure. The example system 1000 can include a service entity computing system 1005 (e.g., that is associated with a delivery service entity or service provider). The example system 1000 can include one or more merchant devices 1010 (e.g., that are associated with one or more merchants). The example system 1000 can include one or more user devices 1015 (e.g., user device of the user). The example system 1000 can include one or more courier devices 1080 (e.g., user device of the operator, user device of the vehicle). One or more of the service entity computing system 1005, the merchant device 1010, the user device 1015, or the courier device 1080 can be communicatively coupled to one another over one or more communication network(s) 1017. The networks 1017 can correspond to any of the networks described herein.

The computing device(s) 1020 of the service entity computing system 1005 can include processor(s) 1025 and a memory 1030. The one or more processors 1025 can be any suitable processing device (e.g., a processor core, a microprocessor, an ASIC, a FPGA, a controller, a microcontroller) and can be one processor or a plurality of processors that are operatively connected. The memory 1030 can include one or more non-transitory computer-readable storage media, such as RAM, ROM, EEPROM, EPROM, one or more memory devices, flash memory devices, data registrar, etc., and combinations thereof.

The memory 1030 can store information that can be accessed by the one or more processors 1025. For example, the memory 1030 (e.g., one or more non-transitory computer-readable storage mediums, memory devices) can include computer-readable instructions 1030A that can be executed by the one or more processors 1025. The instructions 1030A can be software written in any suitable programming language or can be implemented in hardware. Additionally or alternatively, the instructions 1030A can be executed in logically or virtually separate threads on processor(s) 1025.

For example, the memory 1030 can store instructions 1030A that when executed by the one or more processors 1025 cause the one or more processors 1025 (the service entity computing system 1005) to perform operations such as any of the operations and functions of the computing system(s) (e.g., operations computing system) described herein (or for which the system(s) are configured), one or more of the operations and functions for communicating between the computing systems, one or more portions/operations of method(s) 700, 800, or one or more of the other operations and functions of the computing systems described herein.

The memory 1030 can store data 1030B that can be obtained (e.g., acquired, received, retrieved, accessed, created, stored). The data 1030B can include, for example, any of the data/information described herein. In some implementations, the computing device(s) 1020 can obtain data from one or more memories that are remote from the service entity computing system 1005.

The computing device(s) 1020 can also include a communication interface 1035 used to communicate with one or more other system(s) remote from the service entity computing system 1005, such as merchant device 1010, user device 1015, or courier device 1080. The communication interface 1035 can include any circuits, components, software, etc. for communicating via one or more networks (e.g., network(s) 1017). The communication interface 1035 can include, for example, one or more of a communications controller, receiver, transceiver, transmitter, port, conductors, software or hardware for communicating data.

The merchant device 1010 can include one or more computing device(s) 1040 that are remote from the service entity computing system 1005, the user device 1015, and the courier device 1080. The computing device(s) 1040 can include one or more processors 1045 and a memory 1050. The one or more processors 1045 can be any suitable processing device (e.g., a processor core, a microprocessor, an ASIC, a FPGA, a controller, a microcontroller) and can be one processor or a plurality of processors that are operatively connected. The memory 1050 can include one or more tangible, non-transitory computer-readable storage media, such as RAM, ROM, EEPROM, EPROM, one or more memory devices, flash memory devices, data registrar, etc., and combinations thereof.

The memory 1050 can store information that can be accessed by the one or more processors 1045. For example, the memory 1050 (e.g., one or more tangible, non-transitory computer-readable storage media, one or more memory devices) can include computer-readable instructions 1050A that can be executed by the one or more processors 1045. The instructions 1050A can be software written in any suitable programming language or can be implemented in hardware. Additionally or alternatively, the instructions 1050A can be executed in logically or virtually separate threads on processor(s) 1045.

For example, the memory 1050 can store instructions 1050A that when executed by the one or more processors 1045 cause the one or more processors 1045 to perform operations such as any of the operations and functions of the computing system(s) (e.g., merchant server) described herein (or for which the system(s) are configured), one or more of the operations and functions for communicating between computing systems, one or more portions/operations of method 1100, or one or more of the other operations and functions of the computing systems described herein. The memory 1050 can store data 1050B that can be obtained. The data 1050B can include, for example, any of the data/information described herein.

The computing device(s) 1040 can also include a communication interface 1060 used to communicate with one or more system(s) that are remote from the merchant device 1010. The communication interface 1060 can include any circuits, components, software, etc. for communicating via one or more networks (e.g., network(s) 1017). The communication interface 1060 can include, for example, one or more of a communications controller, receiver, transceiver, transmitter, port, conductors, software or hardware for communicating data.

The user device 1015 can include one or more computing device(s) 1065 that are remote from the service entity computing system 1005, the merchant device 1010, and the courier device 1080. The computing device(s) 1065 can include one or more processors 1067 and a memory 1070. The one or more processors 1067 can be any suitable processing device (e.g., a processor core, a microprocessor, an ASIC, a FPGA, a controller, a microcontroller) and can be one processor or a plurality of processors that are operatively connected. The memory 1070 can include one or more tangible, non-transitory computer-readable storage media, such as RAM, ROM, EEPROM, EPROM, one or more memory devices, flash memory devices, data registrar, etc., and combinations thereof.

The memory 1070 can store information that can be accessed by the one or more processors 1067. For example, the memory 1070 (e.g., one or more tangible, non-transitory computer-readable storage media, one or more memory devices) can include computer-readable instructions 1070A that can be executed by the one or more processors 1067. The instructions 1070A can be software written in any suitable programming language or can be implemented in hardware. Additionally or alternatively, the instructions 1070A can be executed in logically or virtually separate threads on processor(s) 1067.

For example, the memory 1070 can store instructions 1070A that when executed by the one or more processors 1067 cause the one or more processors 1067 to perform operations such as any of the operations and functions of the computing system(s) (e.g., user devices) described herein (or for which the user device(s) are configured), one or more of the operations and functions for communicating between systems, one or more portions/operations of method 1100, or one or more of the other operations and functions of the computing systems described herein. The memory 1070 can store data 1070B that can be obtained. The data 1070B can include, for example, any of the data/information described herein.

The computing device(s) 1065 can also include a communication interface 1075 used to communicate computing device/system that is remote from the user device 1015, such as merchant device 1010, service entity computing system 1005, or courier device 1080. The communication interface 1075 can include any circuits, components, software, etc. for communicating via one or more networks (e.g., network(s) 1017). The communication interface 1075 can include, for example, one or more of a communications controller, receiver, transceiver, transmitter, port, conductors, software or hardware for communicating data.

The computing device(s) 1085 of the courier device 1080 can include processor(s) 1087 and a memory 1090. The one or more processors 1087 can be any suitable processing device (e.g., a processor core, a microprocessor, an ASIC, a FPGA, a controller, a microcontroller) and can be one processor or a plurality of processors that are operatively connected. The memory 1090 can include one or more non-transitory computer-readable storage media, such as RAM, ROM, EEPROM, EPROM, one or more memory devices, flash memory devices, data registrar, etc., and combinations thereof.

The memory 1090 can store information that can be accessed by the one or more processors 1087. For example, the memory 1090 (e.g., one or more non-transitory computer-readable storage mediums, memory devices) can include computer-readable instructions 1090A that can be executed by the one or more processors 1087. The instructions 1090A can be software written in any suitable programming language or can be implemented in hardware. Additionally or alternatively, the instructions 1090A can be executed in logically or virtually separate threads on processor(s) 1087.

For example, the memory 1090 can store instructions 1090A that when executed by the one or more processors 1087 cause the one or more processors 1087 (the courier device 1080) to perform operations such as any of the operations and functions of the display device(s) described herein (or for which such devices are configured), one or more of the operations and functions for communicating between the computing systems/devices, one or more portions/operations of method 1100, or one or more of the other operations and functions of the computing systems described herein.

The memory 1090 can store data 1090B that can be obtained (e.g., acquired, received, retrieved, accessed, created, stored). The data 1090B can include, for example, any of the data/information described herein. In some implementations, the computing device(s) 1085 can obtain data from one or more memories that are remote from the courier device 1080.

The computing device(s) 1085 can also include a communication interface 1095 used to communicate with one or more other system(s) remote from the courier device 1080, such as merchant device 1010, user device 1015, or service entity computing system 1005. The communication interface 1095 can include any circuits, components, software, etc. for communicating via one or more networks (e.g., network(s) 1017). The communication interface 1095 can include, for example, one or more of a communications controller, receiver, transceiver, transmitter, port, conductors, software or hardware for communicating data.

The network(s) 1017 can be any type of network or combination of networks that allows for communication between devices. In some implementations, the network(s) 1017 can include one or more of a local area network, wide area network, the Internet, secure network, cellular network, mesh network, peer-to-peer communication link or some combination thereof and can include any number of wired or wireless links. Communication over the network(s) 1017 can be accomplished, for example, via a communication interface using any type of protocol, protection scheme, encoding, format, packaging, etc.

Computing tasks discussed herein as being performed at certain computing device(s)/systems can instead be performed at another computing device/system, or vice versa. Such configurations can be implemented without deviating from the scope of the present disclosure. The use of computer-based systems allows for a great variety of possible configurations, combinations, and divisions of tasks and functionality between and among components. Computer-implemented operations can be performed on a single component or across multiple components. Computer-implemented tasks or operations can be performed sequentially or in parallel. Data and instructions can be stored in a single memory device or across multiple memory devices.

Aspects of the disclosure have been described in terms of illustrative embodiments thereof. Numerous other embodiments, modifications, or variations within the scope and spirit of the appended claims can occur to persons of ordinary skill in the art from a review of this disclosure. Any and all features in the following claims can be combined or rearranged in any way possible. Accordingly, the scope of the present disclosure is by way of example rather than by way of limitation, and the subject disclosure does not preclude inclusion of such modifications, variations or additions to the present subject matter as would be readily apparent to one of ordinary skill in the art. Moreover, terms are described herein using lists of example elements joined by conjunctions such as “and,” “or,” “but,” etc. It should be understood that such conjunctions are provided for explanatory purposes only.

Lists joined by a particular conjunction such as “or,” for example, can refer to “at least one of” or “any combination of” example elements listed therein, with “or” being understood as “and/or” unless otherwise indicated. Also, terms such as “based on” should be understood as “based at least in part on.”

Those of ordinary skill in the art, using the disclosures provided herein, will understand that the elements of any of the claims discussed herein can be adapted, rearranged, expanded, omitted, combined, or modified in various ways without deviating from the scope of the present disclosure. Some implementations are described with a reference numeral for example illustrated purposes and are not meant to be limiting.

What is claimed is:

1. A computer-implemented method comprising:
accessing service request data indicative of a service request, the service request having a service type and one or more service parameters;
computing a complexity score associated with the service request based on the service type and the one or more service parameters;
selecting a first courier of a plurality of candidate couriers based on the complexity score associated with the service request; and
outputting first instructions to a first courier device associated with the first courier, wherein the first instructions are executable by the first courier device to cause a service assignment to be provided for display via a user interface of the first courier device, the service assignment indicating the first courier is to perform the service request.

2. The computer-implemented method of claim 1, wherein the method further comprises:
accessing first courier data associated with the first courier, the first courier data describing values of one or more courier-level features associated with the first courier; and
computing a complexity threshold associated with the first courier based on the first courier data;
wherein selecting the first courier comprises associating the first courier and the service request based on a comparison of the complexity score associated with the service request to the complexity threshold associated with the first courier.

3. The computer-implemented method of claim 2, wherein selecting the first courier comprises:
computing a first time estimate for the first courier to complete the service request based on the service type and the one or more service parameters;
computing a first adjusted time estimate by adjusting the first time estimate based on the first courier data; and
selecting the first courier based on the first adjusted time estimate.

4. The computer-implemented method of claim 3, further comprising:
accessing second courier data associated with a second courier, the second courier data describing values of the one or more courier-level features associated with the second courier; and
computing a second time estimate for the second courier to complete the service request based on the service type and the one or more service parameters;
wherein selecting the first courier is based on a comparison between the first adjusted time estimate and the second time estimate.

5. The computer-implemented method of claim 3, wherein the one or more courier-level features comprise historical service data respective to a plurality of service types, wherein the service type of the service request is a first service type of the plurality of service types; and
wherein computing the first adjusted time estimate comprises adjusting the first time estimate based on the historical service data of the first courier.

6. The computer-implemented method of claim 5, wherein selecting the first courier comprises:
accessing a service count of a second service type of the plurality of service types in the historical service data of the first courier, the second service type having a second base complexity that is lower than a first base complexity of the first service type;
computing a service count threshold indicative of a number of services of the second service type to be completed by the first courier prior to assigning the first courier to service requests of the first service type;
computing that the service count of the second service type satisfies the service count threshold; and
selecting the first courier in response to computing that the service count of the second service type is greater than the service count threshold.

7. The computer-implemented method of claim 5, further comprising computing a historical complexity score associated with the historical service data of the first courier;
wherein adjusting the first time estimate is based on a comparison of the historical complexity score to the complexity score of the service request.

8. The computer-implemented method of claim 7, wherein adjusting the first time estimate comprises decreasing the first time estimate if the historical complexity score is greater than the complexity score of the service request.

9. The computer-implemented method of claim 3, wherein the one or more courier-level features comprise a courier rank within a plurality of courier ranks;
wherein the computer-implemented method further comprises computing a first courier rank of the first courier, the first courier rank within the plurality of courier ranks; and
wherein computing the first adjusted time estimate is based on the first courier rank.

10. The computer-implemented method of claim 9, wherein computing the first courier rank comprises:
accessing data indicative of a ranking score of the first courier;
accessing a courier rank table indicating a tiered relationship between ranking scores and the plurality of courier ranks; and
computing the first courier rank based on a comparison of the ranking score of the first courier to the courier rank table based on the tiered relationship between ranking scores and the plurality of courier ranks.

11. The computer-implemented method of claim 9, further comprising outputting data indicative of the first courier rank to the first courier device.

12. The computer-implemented method of claim 9, wherein computing the first adjusted time estimate comprises:
computing a first time modifier associated with a first courier rank of the first courier; and
applying the first time modifier to the first time estimate to compute the first adjusted time estimate.

13. The computer-implemented method of claim 12, wherein computing the first time modifier comprises:
accessing a time modifier table indicating a respective relationship between a plurality of time modifiers and the plurality of courier ranks; and
computing the first time modifier based on a comparison between the first courier rank and the time modifier table based on the respective relationship between the plurality of time modifiers and the plurality of courier ranks.

14. The computer-implemented method of claim 9, wherein the first time estimate is based on a first distance estimate indicative of distance traveled by the first courier in completing the service request; and
wherein computing the first adjusted time estimate comprises:
computing a first distance modifier associated with a first courier rank of the first courier;
applying the first distance modifier to the first distance estimate to produce a first adjusted distance estimate; and
computing the first adjusted time estimate based on the first adjusted distance estimate.

15. The computer-implemented method of claim 1, wherein the service type comprises at least one of: food delivery, courier-packed retail delivery, merchant-packed retail delivery, courier-packed grocery delivery, or merchant-packed grocery delivery.

16. The computer-implemented method of claim 1, wherein the one or more service parameters are indicative of at least one of: a number of items to be transported, an order size, a batch size, a hyperbatching attribute, an item weight, an item size, an origin, an intermediate destination, a final destination, a service quality, a service priority, a service requirements, service metrics, or a product type.

17. A computing system comprising:
one or more processors; and
one or more non-transitory, computer-readable media storing instructions that are executable by the one or more processors to cause the computing system to perform operations, the operations comprising:
accessing service request data indicative of a service request, the service request having a service type and one or more service parameters;
computing a complexity score associated with the service request based on the service type and the one or more service parameters;
selecting a first courier of a plurality of candidate couriers based on the complexity score associated with the service request; and
outputting first instructions to a first courier device associated with the first courier, wherein the first instructions are executable by the first courier device to cause a service assignment to be provided for display via a user interface of the first courier device, the service assignment indicating the first courier is to perform the service request.

18. The computing system of claim 17, wherein the operations further comprise:
accessing first courier data associated with the first courier, the first courier data describing values of one or more courier-level features associated with the first courier; and
computing a complexity threshold associated with the first courier based on the first courier data;
wherein selecting the first courier comprises associating the first courier and the service request based on a comparison of the complexity score associated with the service request to the complexity threshold associated with the first courier.

19. The computing system of claim 18, wherein selecting the first courier comprises:
computing a first time estimate for the first courier to complete the service request based on the service type and the one or more service parameters;
computing a first adjusted time estimate by adjusting the first time estimate based on the first courier data; and
selecting the first courier based on the first adjusted time estimate.

20. One or more non-transitory, computer-readable media storing instructions comprising operations, the operations comprising:
accessing service request data indicative of a service request, the service request having a service type and one or more service parameters;
computing a complexity score associated with the service request based on the service type and the one or more service parameters;
selecting a first courier of a plurality of candidate couriers based on the complexity score associated with the service request; and
outputting first instructions to a first courier device associated with the first courier, wherein the first instructions are executable by the first courier device to cause a service assignment to be provided for display via a user interface of the first courier device, the service assignment indicating the first courier is to perform the service request.
